(19) United States
(12) Patent Application Publication
(10) Pub. No.: US 2011/0226915 A1
(43) Pub. Date: Sep. 22, 2011

(54) GARBAGE CONTAINER PLATFORM

(76) Inventor: Douglas Perrette, Gulfport, MS (US)

(21) Appl. No.: 13/050,270

(22) Filed: Mar. 17, 2011

Related U.S. Application Data
(60) Provisional application No. 61/314,995, filed on Mar. 17, 2010.

(51) Int. Cl. F16M 11/22

(52) U.S. Cl. 248/146

(57) ABSTRACT

A platform assembly for supporting a garbage container comprising: a frame, where the frame includes four sides and creates a support means for the garbage container; at least two cross-bars, where said cross bars are connected in parallel with two connectors, and said assembly creates a rectangular shape; two anchor posts, where one anchor post is connected at each outside edge of each outside cross-bar at a first end of the platform, said anchor post capable of being driven into the ground to support the frame; a quick release pin for each anchor post, where said pin provides a means to adjust the height of the frame along the anchor post; and two anchor pins at a second end of the platform, one connected to each outside cross-bar, where said anchor pins are driven into the ground to support the platform in a stable position.

### CROSS REFERENCE TO OTHER APPLICATIONS

This application claims priority to U.S. Provisional Application Ser. No. 61/314,995 filed on Mar. 17, 2010.

### BACKGROUND OF THE INVENTION

1. Field of Invention

The present invention relates to a platform for ditches or uneven ground for placement of garbage receptacles.

2. Description of Related Art

Many residential homes must deposit or place garbage containers at a roadside location for pickup by garbage trucks. Some systems include specialized garbage cans that are placed for access by the garbage truck or other garbage containers are manually handled by garbage personnel. When the garbage containers are placed at a roadside location occasionally they may topple over or obstruct traffic depending on the roadside conditions in front of the residence. Some residences in rural or suburban areas may include a drainage ditch traveling in front of the property line. Because the presence of the drainage ditch creates an uneven or sometimes unstable ground surface the likelihood of a toppling garbage container increases. Further placement of the garbage can in a driveway or on a roadside also increases the likelihood of the can being struck by a moving vehicle. Further once the garbage personnel empty the container it may be left on its side or tossed randomly. It would therefore be advantageous to have a platform for placing a garbage container that is being set out for collection by the garbage collector.

### SUMMARY OF THE INVENTION

The present invention relates to a platform assembly for supporting a garbage container comprising: a frame, where the frame includes four sides and creates a support means for the garbage container; at least two cross-bars, where said cross bars are connected in parallel with two connectors, and said assembly creates a rectangular shape; two anchor posts, where one anchor post is connected at each outside edge of each outside cross-bar at a first end of the platform, said anchor post capable of being driven into the ground to support the frame; a quick release pin for each anchor post, where said pin provides a means to adjust the height of the frame along the anchor post; and two anchor pins at a second end of the platform, one connected to each outside cross-bar, where said anchor pins are driven into the ground to support the platform in a stable position.

### BRIEF DESCRIPTION OF DRAWINGS

FIG. 1 depicts a plan of a platform bridge according to the present invention.

FIG. 2 depicts surface area of a garbage container.

FIG. 3 depicts an elevation view of a platform according to the present invention.

FIG. 4 depicts detailed components of the platform according to the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention provides a platform as a mounting device for placement of a ditch in order to support the curbside placement of a garbage container. The platform provides a means to place the garbage container out of the traffic area and to prevent the accidental toppling over of the container once it is placed in a position for garbage collection. The platform has a frame that expands over the width of the ditch and is mounted into the ground surface near the edges of the ditch. Once mounted into the ground surface, it may be adjusted to a height that provides a level platform for placement of a garbage container.

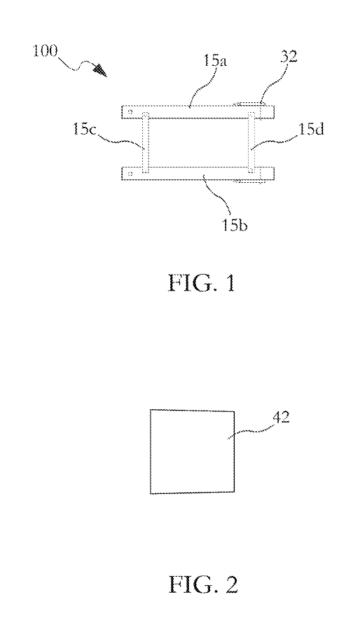

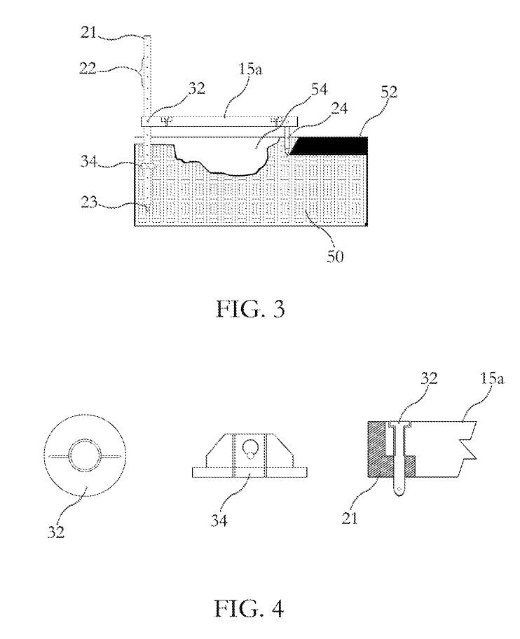

FIG. 1 depicts a plan view of a Platform 100 according to the invention. The Platform 100 includes a frame that has four sides thereof to create the support means for a garbage container. The Platform 100 includes two Cross-Bars 15a, 15b that are connected by Connectors 15c, 15d. The Platform 100 creates a substantially rectangular shape that extends across a ditch where the Cross-Bars 15a, 15b extend across the ditch. Connected at each outside edge of each cross-bar is an Anchor Post 21 that is attached to the cross-bar by use of a Release Pin 32. FIG. 3 depicts an elevation view of the Platform 100 as it is mounted over a ditch. As the platform is placed over a Ditch 54 the Anchor Post 21 is driven into the Ground 50 at one end of the platform and at a second end of the Platform 100 on the other side of the ditch, an Anchor Pin 24 is driven into the ground to support the Platform 100 in a stable position. The Platform 100 is adjustable along the length of the Anchor Post 21 through the use of a quick Release Pin 32 on each respective anchor post. The Release Pin 32 may be placed along any available Height-Adjusting Hole 22 provided along the length of the Anchor Post 21. The Driving End 23 of the anchor post is driven into the ground and includes an Anchor Collar 34 positioned along the length thereof to firmly support the Anchor Post 21 into the ground. The Cross-Bars 15a, 15b extend over the open area of the Ditch 54 and therefore supplies a surface for the placement of a garbage container. The Anchor Pin 24 is driven into the ground just before the Pavement 52.

In one particular embodiment of the present invention, the length of the Cross-Bars 15a, 15b are 4 feet in length and are separated by 1½ feet. Such dimensions are suitable for the surface area of the garbage container. Typically a garbage container has a surface area as depicted in FIG. 2 but the size of the container may vary from 1 foot 9 inches to 2 feet. Consequently, the Platform 100 provides a firm support for the garbage container that may be placed over open ditches as depicted in FIG. 3.

FIG. 4 depicts detail of the components of the present invention. The top head surface of the quick Release Pin 32 is shown in FIG. 4. The top head surface is counter-synced so that the pin may be placed through the Cross-Bar 15a and into the Anchor Post 21 as depicted in the cross-section provided in FIG. 4. Also the cross-section of the Anchor Column 34 is provided that is placed upon the anchor and driven into the ground surface area to firmly support the Anchor Post 21.

The Platform 100 according to present invention provides a means for the placement of garbage containers over an uneven ground to avoid toppling over, obstructing traffic or spilling the contents thereof. The platform is adjustable along the anchor post and is easily positioned to provide a level surface for the placement of a garbage container. The platform also may be easily disassembled so that it can be relocated as needed or adjusted to changes in the ground surface conditions. The instant invention has been shown and described in what it considers to be the most practical and preferred embodiments. It is recognized, however, that departures may be made there from within the scope of the invention and that obvious modifications will occur to a person skilled in the art.

What is claimed is:

1. A platform assembly for supporting a garbage container comprising:
a. a frame, where the frame includes four sides and creates a support means for the garbage container;
b. at least two cross-bars, where said cross bars are connected in parallel with two connectors, and said assembly creates a rectangular shape;
c. two anchor posts, where one anchor post is connected at each outside edge of each outside cross-bar at a first end of the platform, said anchor post capable of being driven into the ground to support the frame;
d. a quick release pin for each anchor post, where said pin provides a means to adjust the height of the frame along the anchor post; and
e. two anchor pins at a second end of the platform, one connected to each outside cross-bar, where said anchor pins are driven into the ground to support the platform in a stable position.
